(19) United States
(12) Patent Application Publication
(10) Pub. No.: US 2018/0016382 A1
(43) Pub. Date: Jan. 18, 2018

(54) CAST URETHANES MADE FROM LOW FREE MONOMER PREPOLYMER WITH POLYCARBONATE BACKBONE

(71) Applicant: LANXESS SOLUTIONS US INC., Middlebury, CT (US)

(72) Inventors: Zhenya Zhu, New Milford, CT (US); Gerald King, Eglinton (GB); George Brereton, Mahopac, NY (US)

(21) Appl. No.: 15/649,746

(22) Filed: Jul. 14, 2017

Related U.S. Application Data
(60) Provisional application No. 62/362,370, filed on Jul. 14, 2016.

(51) Int. Cl. C08G 18/44; C08G 18/10; C08G 18/42; C08G 85/00

(52) U.S. Cl. CPC C08G 18/44; C08G 85/002; C08G 18/10; C08G 18/4286

(57) ABSTRACT

Polycarbonate based polyurethane prepolymers having a low amount of free isocyanate monomer with excellent handling and processing properties are prepared and used in the preparation of cast polyurethane polymers with excellent performance and handling properties.

Provided are polycarbonate based polyurethane prepolymers having low free isocyanate monomer content and excellent handling characteristics prepared from select polycarbonate polyols or co-polycarbonate polyols, easily processed polyurethane curing compositions comprising said prepolymers, polyurethane polymers with excellent physical properties prepared therefrom, and a process for casting polyurethane polymers from the curing compositions are provided.

### BACKGROUND OF THE INVENTION

Polyurethane polymers, prepared from polyols, polyisocyanates and typically a crosslinker, are well known as tough engineering materials, often having better strength and resilience than other similar materials, such as naturally occurring rubbers. The excellent elastomeric properties found in many high performance polyurethane elastomers and thermoplastics result in large part from the presence and interactions of a “soft segment”, generally associated with the polyol component, and a “hard segment” associated with the urethane and urea linkages formed by reactions of the polyisocyanate. The selection of polyol and polyisocyanate therefore has significant impact on the properties of the resulting resin.

A wide variety of polyols have been used as the soft segments of polyurethane polymers, including polyether polyols, such as polyethylene glycol, polypropylene glycol, or poly tetramethylene ether glycol; polyester polyols, such as those formed from a polycarboxylic acid like adipic acid with a polyol like ethylene glycol; polylactone polyols, such as polycaprolactone polyol; polycarbonate polyols and the like. Of these, polycarbonate polyols are generally associated with polyurethanes having very high levels of toughness and weatherability. For example, polyurethanes prepared from polycarbonate polyols are often more resistant to hydrolysis than polyurethanes prepared from polyester or polylactone polyols, and are generally more resistant to oxidative degradation than polyurethanes prepared from polyether polyols. U.S. Pat. No. 5,066,762 discloses a thermoplastic polyurethane resin prepared from a PPDI/polycarbonate prepolymer and a C₂₋₁₀ diol curing agent possessing excellent toughness and other desirable physical properties.

The most widely used polycarbonate polyol in polyurethanes is based on 1,6-hexanediol, which can produce a polyurethane resin having a very good balance of various properties, including mechanical strength, and excellent resistance to high temperatures, moisture, etc.

However, there can be drawbacks in the use of polycarbonate polyols, both in terms of processability and resultant physical properties. For example, polycarbonate diols having 1,6-hexanediol structures in the main chain tend to be relatively hard, wax-like solids at ordinary temperatures, and polyurethanes prepared from polycarbonate polyols, such as 1,6-hexanediol polycarbonate diol, are often difficult to process due to high viscosity and melting points. Many polycarbonate polyurethanes exhibit poor flexibility or elastic recovery and, as disclosed in U.S. Pat. No. 5,070,173, producing a fiber from such a polyurethane may be difficult because of the poor spinnability of the polymer. It has also been found that the soft segments of some polyurethanes comprising 1,6-hexanediol polycarbonate polyol have a tendency to crystallize at low temperatures and may not be sufficiently oil resistant.

Given the stability of the polycarbonate linkage in aliphatic polycarbonate polyols, and in the polyurethanes prepared from them, efforts have been made to provide polycarbonate polyols, especially polycarbonate diols, that can be used in the preparation of high performance polyurethane elastomers that maintain the toughness and weatherability advantages of 1,6-hexanediol polycarbonate diol based elastomers while providing improved processability and physical characteristics such as flexibility, elasticity, etc.

To this end, co-polycarbonate polyols have been developed. U.S. Pat. No. 4,103,070 discloses a polycarbonate diol useful in preparing an amorphous polyurethane synthesized from a mixture of 1,6-hexanediol and 1,4-cyclohexanedimethanol. U.S. Pat. No. 4,013,702 discloses a co-polycarbonate diol from a mixture of 1,6-hexanediol and 1,4-butanediol.

U.S. Pat. No. 5,070,173 discloses a co-polycarbonate diol comprising a 9:1 to 1:9 ratio of units derived from 1,6-hexane diol and 1,5-pentane diol, i.e., 1,6/1,5-copolyester diols, with a number average molecular weight of from 300 to 50,000 and polyurethanes prepared therefrom, which polyurethanes have excellent resistance to hydrolysis, light, chlorine, oxidative degradation, heat, etc., and improved flexibility and elastic recovery. U.S. Pat. Nos. 7,005,496 and 8,168,782 also describe polyurethane polymers prepared from 1,6/1,5-copolyester diols and other similar materials.

One common method for the production of polyurethanes comprises reacting an isocyanate terminated prepolymer, prepared from the reaction of a polyol with a molar excess of polyisocyanate monomer, with a curing agent, such as a polyol and/or polyamine. Often a large excess of polyisocyanate monomer is used leaving a quantity of unreacted isocyanate monomer, at least a portion of which is generally removed.

U.S. Pat. No. 5,703,193 and US Pat Appl 20090076239 disclose the preparation of prepolymers containing very low levels of free isocyanate monomers, e.g., less than 3%, 1% or 0.1% by weight based on the weight of the prepolymer, which low free isocyanate monomer prepolymers have been used to prepare polyurethane curing compositions with good handling properties and elastomeric polyurethanes with good performance properties.

Polycarbonate backbone polyurethanes typically exhibit good property retention in water, high resistance to chemicals and oil, and maintain strength and other properties at high temperatures, but can be difficult to prepare and process due to high viscosity and high melting points of the polyurethanes and the prepolymers used in their preparation. It has been found that improvements in the production and properties of polycarbonate based polyurethanes, can be realized by reacting a curing agent with certain low free isocyanate monomer polycarbonate prepolymers having less than 1 wt %, preferably less than 0.1 wt %, free isocyanate monomer.

### SUMMARY OF THE INVENTION

Certain polycarbonate based prepolymers having a free polyisocyanate monomer content of less than 1 wt %, typically less than 0.5 and preferably 0.1 wt %, prepared from a polyol component comprising one or more polycarbonate polyol, one or more co-polycarbonate polyol, e.g., 1,5/1,6 co-carbonate polyol, or a mixture thereof, have been found to have lower melting points and exhibit lower viscosity than other similar materials. The use of these prepolymers provides an efficient way prepared polycarbonate based polyurethanes, e.g., polycarbonate polyurethane elastomers, and thereby improve the performance of the resulting polymer, e.g., elastomer.

In the present disclosure, a “polycarbonate polyol” and “co-polycarbonate polyol” comprise at least two hydroxyl groups and moieties of formula I wherein x is a divalent organic group, e.g., a divalent alkyl, aryl, alkylene ether, etc.

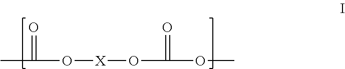

Each moiety of formula I in a “polycarbonate polyol” is the same, that is, a “polycarbonate polyol” comprises as “repeating units” moieties of formula I wherein the value of x in each moiety present is the same. A “co-polycarbonate polyol” comprises at least two different moieties of formula I, that is, a co-polycarbonate polyol comprises more that one moiety of formula I wherein the value for x differs.

Generally, each of the moieties of formula I appear in a polyol multiple times, and as such are referred to as repeating units. However, in some embodiments, e.g., certain co-polycarbonate polyols, only a single occurrence of a moiety of formula I may be present, but the term “repeating unit” is still used in reference to this moiety to be consistent with the majority of the embodiments.

For clarity, it is to be understood that in the embodiments described below, the presence of more than one “repeating units of formula I”, etc., means that at least two different moieties of that generic formula, but having a different specific structure, is present.

One broad embodiment of the invention provides an isocyanate terminated polycarbonate prepolymer, prepared by reacting a polycarbonate polyol and/or co-polycarbonate polyol with a polyisocyanate monomer, which prepolymer has a free poly isocyanate monomer content of less than 1 wt %, typically less than 0.5 or 0.1 wt %, based on the weight of the prepolymer.

In the present application, the article “a” or “an” means one or more than one unless otherwise specified, and more than one polyol and/or polyisocyanate monomer may be used.

Particular embodiments provide a low free isocyanate monomer polycarbonate prepolymer prepared from a polyol comprising a repeating unit of formula A and one or more repeating units of formula B, in a molar ratio of A to all repeating units of B of from 9:1 to 1:9, 4:1 to 1:4, or 4:1 to 1:3:

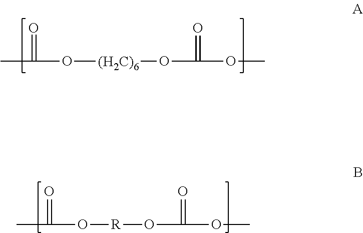

wherein R is C₂₋₁₂ alkyl other than straight chain C₆H₁₂. In some embodiments, more than one repeating unit of formula B are present, i.e., repeating units with different values for R; in some embodiments only one repeating unit of formula B is present.

Another broad embodiment provides polyurethane polymers prepared by reacting the prepolymers of the invention with a curing agent comprising a polyol, polyamine and/or polyamine derivative. Other embodiments provide curing compositions comprising one or more of the above prepolymers and a curing agent, a method for preparing the prepolymers, and a method for preparing cast polyurethane polymers using the inventive prepolymers. Cast polyurethane elastomers of the invention generally have excellent physical properties, e.g., polyurethanes obtained from a low free monomer prepolymer of the invention prepared from a 1,5/1,6 co-polycarbonate polyol have been shown to exhibit exceptional physical property retention in oil and chemical environments at temperatures as high as 150° C.

### DESCRIPTION OF THE INVENTION

A low free isocyanate monomer prepolymer of the invention contains less than 1 wt %, e.g., less than 0.5 wt %, preferably less than 0.1 wt %, or less than 0.05 wt %, free polyisocyanate monomer, based on the total weight of the prepolymer. The inventive prepolymer is prepared by reacting a polyol component comprising one or more polycarbonate polyol comprising a repeating unit of formula I, one or more co-polycarbonate polyol comprising more than one repeating unit of formula I, or a mixture thereof,

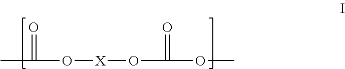

wherein X is a C₂₋₁₂ alkyl group, e.g., C₄₋₈ alkyl group or C₂₋₁₂ alkyl group, with a 1.5:1 to 15:1 molar excess, e.g., a 2:1 to 15:1 or 3:1 to 12:1 molar excess, of polyisocyanate monomer to obtain a prepolymer product mixture, followed by removing unreacted polyisocyanate monomer, typically by a distillation process and generally under reduced pressure. Typically, the polycarbonate polyols and co-polycarbonate polyols are diols and typically the polyisocyanate monomers are diisocyanates. In some embodiments distillation of unreacted polyisocyanate monomer occurs in the presence of solvent, e.g., one or more inert organic solvent.

In particular embodiments, the low free isocyanate monomer prepolymer of the invention is prepared by reacting a co-polycarbonate polyol, typically a co-polycarbonate diol, comprising a repeating unit of formula A and one or more repeating units of formula B,

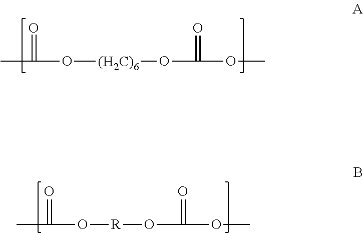

wherein R is C₂₋₁₂ alkyl other than straight chain C₆H₁₂, in a molar ratio of A to all repeating units of formula B of from 9:1 to 1:9, 4:1 to 1:4, or 4:1 to 1:3, with a 1.5:1 to 15:1 molar excess, generally a 2:1 to 15:1 or 3:1 to 12:1 molar excess, of polyisocyanate monomer, typically comprising a diisocyanate monomer, to obtain a prepolymer product mixture, followed by removing unreacted polyisocyanate monomer, typically by distillation and generally under reduced pressure, which distillation, in some embodiments, occurs in the presence of one or more solvents having a boiling point lower than that of the polyisocyanate monomer and/or one or more solvents having a boiling point higher than that of the polyisocyanate monomer.

More than one polycarbonate or co-polycarbonate polyol may be used in preparing the prepolymer. In some embodiments polyols other than polycarbonate or co-polycarbonate polyols may also be used in preparing the prepolymer, but in most embodiments at least 80 wt % or more of the polyols are polycarbonate or co-polycarbonate polyols of the invention. In a particular embodiment, a mixture of polyols comprising a polycarbonate or co-polycarbonate polyol and a polyether polyol, e.g., PTMEG, are used to prepare the prepolymer wherein less than 80 wt %, e.g., from 50 to 80 wt % are polycarbonate or co-polycarbonate polyols. In most embodiments however, 90 to 100%, 95 to 100% or 98 to 100% of all polyols used in preparing the prepolymer of the invention are polycarbonate or co-polycarbonate diols, for example, co-polycarbonate diols comprising repeating units of formula A and B.

Almost any polyisocyanate monomer known in the art may be used to prepare the prepolymer, including, e.g., paraphenylene diisocyanate (PPDI), toluidine diisocyanate (TODI), isophorone diisocyanate (IPDI), 2,4- and/or 4,4′-methylene bis (phenylisocyanate) (MDI), toluene-2,4-diisocyanate (2,4-TDI), toluene-2,6-diisocyanate (2,6-TDI), naphthalene-1,5-diisocyanate (NDI), diphenyl-4,4′-diisocyanate, dibenzyl-4,4′-diisocyanate, stilbene-4,4′-diisocyanate, benzophenone-4,4′diisocyanate, 1,3- and 1,4-xylene diisocyanates, 1,6-hexamethylene diisocyanate (HDI), 1,3-cyclohexyl diisocyanate, 1,4-cyclohexyl diisocyanate (CHDI), the three geometric isomers of 1,1′-methylene-bis(4-isocyanatocyclohexane) (abbreviated collectively as H₁₂ MDI), and mixtures thereof. In certain embodiments, the polyisocyanate monomer component used in preparing the prepolymers comprises MDI, PPDI, 2,4-TDI, 2,6-TDI, HDI and/or H₁₂DI, e.g., MDI, HDI, PPDI, 2,4-TDI and/or 2,6-TDI.

Processes for reacting the isocyanate and polyol components of the prepolymer composition of the invention are well known in the art and need not be discussed in detail here. Often, the reaction to prepare the prepolymer takes place in an inert solvent, which solvent is often present during removal of unreacted polyisocyanate. Suitable solvents include aliphatic or aromatic hydrocarbon solvents, esters, diesters, lactones carbonates, amides, etc., e.g., mesitylene, chlorinated benzenes, glutarates, succinates, adipates, sebacates, phthalates, butyrolactone, propylene carbonate, N-methylpyrollidone and the like.

In particular embodiments, the prepolymer of the invention is prepared by reacting a polyisocyanate, typically a diisocyanate, with a co-polycarbonate polyol, typically a co-polycarbonate diol, comprising repeating units of formula A and one or more of formula B, or a blend of polycarbonate polyols.

Certain co-polycarbonate diols useful in preparing prepolymers of the invention are prepared using methods known in the art and may have a number average molecular weight of from about 300 to about 20,000, e.g., from about 450 to about 5,000 or about 500 to about 3,000, and comprise repeating units derived from 1,6-hexane diol and at least one C₂₋₁₂ diol other than 1,6-hexane diol. The ratio of repeating units derived from 1,6-hexane diol to the other C₂₋₁₂ diols is from 9:1 to 1:9, often from 4:1 to 1:4. In this usage, “derived from 1,6-hexane diol” or “derived from a C₂₋₁₂ diol other than 1,6-hexane diol” does not necessarily mean that the diol per se was used in the synthesis of the co-polycarbonate diol, although a diol could be used. Rather it means that the repeating unit contains a residue derivable from the diol, e.g., a repeating unit derived from 1,6-hexane diol contains a 1,6-dioxyhexane moiety, i.e., a moiety:

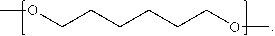

In certain embodiments, the prepolymers of the invention are predominately co-polycarbonate prepolymers wherein 90 to100% of the polyols used to prepared them are co-polycarbonate diols.

In many embodiments, co-polycarbonate diols comprise a repeating unit of formula A derived from 1,6-hexane diol and one or more repeating units of formula B, wherein R is derived from a C₂₋₁₂ alkyl diol other than 1,6-hexane diol in ratio of A to B of from 9:1 to 1:9, 4:1 to 1:4, or 4:1 to 1:3.

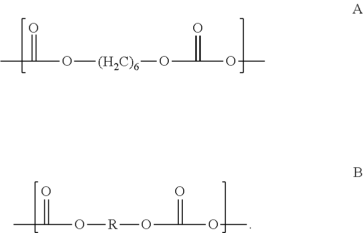

C₂₋₁₂ alkyl in formula B may be linear, such as 1,2-ethylene, 1,3 propylene, 1,4-butylene, 1,5-pentylene, 1,7-heptylene, 1,8-octylene, 1,9-nonylene, 1,10-decylene, 1,11-undecylene and 1,12-dodecylene, branched, such as isopropylene, 1,2-propylene, 1,2-butylene, 1,3-butylene, 2,4-pentylene, 3-methyl-1,5-pentylene and the like, or cyclic such as 1,4-cyclohexylene, 1,4-dimethylenecyclohexane and the like. In many embodiments C₂₋₁₂ alkyl is a linear or branched chain alkylene, for example, C₂₋₁₂, C₃₋₉ or C₄₋₇ linear alkylene, or a C₃₋₁₂, C₃₋₉ or C₄₋₇ branched alkylene. In particular embodiments, R is 1,4-butylene, 1,5-pentylene, 1,9-nonylene, isopropyl, or 3-methy-1,5-pentylene. C₂₋₁₂ alkyl in formula I include those described for formula B but also includes 1,6-hexylene.

There may be more than one repeating unit of formula B in a co-polycarbonate polyol used in preparing the prepolymer of the invention, and obviously the composition of the polyol will be reflected in the prepolymer. In many embodiments one or two repeating units of formula B are present in the polyol and/or prepolymer, in some embodiments there is only one. For example, in one embodiment of the invention, a prepolymer comprising as repeating units A and B⁵ is prepared by reacting a polyol comprising the repeating units A and B⁵ in a 9:1 to 1:9 molar ratio, e.g., a 4:1 to 1:4 molar ratio, with a polyisocyanate:

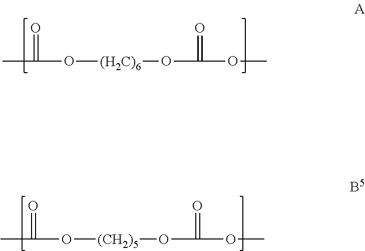

In many embodiments, from 60 to 100% and typically from 75 to 100% of the repeating units A and B in the co-polycarbonate polyol used in preparing a prepolymer of the invention are repeating units of formula A and B⁵. In embodiments where the co-polycarbonate polyol comprises two or more repeating units of formula B, at least 50%, e.g., at least 60% of the repeating units of formula B have the formula B⁵. In many such embodiments, repeating units other than those of formula A and B⁵ are repeating units of formula B wherein R is selected from C₂₋₄ linear alkyl, C₆₋₉ linear alkyl and C₃₋₉ branched alkyl, e.g., C₄ linear alkyl, C₆₋₉ linear alkyl and C₃₋₇ branched alkyl.

A mixture of more than one co-polycarbonate polyol may be used in preparing a predominately co-polycarbonate prepolymer of the invention, and a polyol that is not a co-polycarbonate polyol as described above may be used, however, in many embodiments from 90-100%, typically from 95-100% or 98 to 100%, of all polyols present in the reaction preparing the predominately co-polycarbonate prepolymer of the invention are co-polycarbonate polyols as described above.

Another embodiment of the invention provides a polyurethane curing composition comprising a low free monomer prepolymer of the invention and a curing agent. More than one prepolymer may be present in the curing composition, and prepolymers other than the above polycarbonate prepolymers may be used, but in most embodiments 90-100% of all prepolymers present in the polyurethane curing composition are polycarbonate prepolymers described above. In particular embodiments 90-100% of all prepolymers present in the polyurethane curing composition are predominately co-polycarbonate prepolymers or prepolymers prepared from a blend of more than one polycarbonate polyol as described above. Even when prepolymers not of the invention are present, the amount of free isocyanate monomer in the curing composition is less than 1 wt, e.g., less than 0.5 or 0.1 wt %, based on the weight of all prepolymers present.

Curing agents useful in the polyurethane curing composition may be any curing agents known in the art, e.g., diols, triols, tetrols, higher polyols, diamines, triamines, higher polyamines and the like, and more than one curing agent may be present.

Curing agents, also called coupling agents or cross linking agents, are well known in the art and include various diols, triols, tetrols, diamines or diamine derivatives and the like. Any curing agent providing the desired properties can be employed. Common curing agents include:

C₂₋₁₂ alkylene diols such as ethylene glycol, 1,3-propanediol, 1,4-butanediol, 1,5-pentanediol, 1,6-hexanediol, neopentyl glycol, trimethylol propane, 1,10-decanediol, 1,1-cyclohexane dimethanol, 1,4-cyclohexane dimethanol, cyclohexane diol and the like;

hydroquinone-bis-hydroxyalkyl ethers such as hydroquinone-bis-hydroxyethyl ether, diethylene glycol etc.; ether diols such as dipropylene glycol, dibutylene glycol, triethylene glycol and the like;

and a variety of diamines including ethylene diamine, hexamethylene diamine, isophorone diamine, xylylene diamine, methylenedianiline (MDA), naphthalene-1,5-diamine, ortho, meta, and para-phenylene diamines, toluene-2,4-diamine, dichlorobenzidine, diphenylether-4,4′-diamine, 4,4′-methylene-bis(3-chloroaniline) (MBCA), 4,4′-methylene-bis(3-chloro-2,6-diethylaniline) (MCDEA), diethyl toluene diamine (DETDA), tertiary butyl toluene diamine (TBTDA), dimethylthio-toluene diamine, trimethylene glycol di-p-amino-benzoate, 1,2-bis(2-aminophenylthio)ethane, and methylenedianiline-sodium chloride complexes. One or more than one curing agent may be used.

For example, in some embodiments the curing agent comprises a diol or other polyol, in some other embodiments the curing agent comprises a polyamine, e.g., diamine, or a diamine sodium chloride coordination complex. In some embodiments, the curative comprises a mixture of polyols, a mixture of polyamines, or a mixture of one or more polyols with one or more polyamines, e.g., a C₂₋₆ diol, cyclohexane dimethanol and/or hydroquinone-bis-hydroxyethyl ether. In certain particular embodiments the curing agent comprises 1,4-butane diol and/or hydroquinone-bis-hydroxyethyl ether, for example, 1,4-butanediol. The curing agent may also comprise higher molecular weight diols, MW of 250 or higher, e.g., polyether polyols such as PTMG, polyester polyols, polycaprolactone polyols or polycarbonate polyols, prepolymers, typically as a blend with a diol or triol.

The molar ratio of prepolymer to curing composition may be in the range of from 0.5:1 to 1.5:1, e.g., from 0.7:1 to 1.2:1 or from 1.1:1 to 0.95:1. The amount of curing composition to be added may also be determined by methods well known to one of ordinary skill in the art and will depend on the desired characteristics of the polymer being formed. In some embodiments catalysts may be used in conjunction with the curative.

Other materials used in the art may also be present in the curing compositions including catalysts, dispersants, colorants, fillers, reinforcing agents, solvents, plasticizers, anti-oxidants, UVAs, light stabilizers, lubricants, processing aids, anti-stats, flame retardants, and the like.

Other embodiments provide a method for casting a polyurethane elastomer from a composition comprising the prepolymer of the invention and the elastomer itself. The elastomers are prepared by casting the inventive curing composition into a mold or onto a surface and allowing the composition to cure. Curing often comprises heating the composition at temperatures from about 35 to 150° C., e.g., from 45 to 150, or from 50 to 125° C., such as, from 50 to 100 or 120° C., and such heating may be used in preparation of the curing composition. Often a post cure period is used wherein after the composition cast and allowed to harden somewhat, it is held at elevated temperatures, such as 50 to 150° C., e.g., 70 to 120° C. or from 80 to 120° C., for a period of time.

The polyurethane elastomers prepared according to the invention have well balanced performance characteristics including hydrolysis resistance and heat resistance; excellent physical properties, such as strength and impact resilience; and good flexibility.

The polyurethane polymers produced according to the invention can be used in a variety of film, sheet and profile applications, for example casters, wheels, rollers, tires, belts, sporting goods such as golf ball cores, golf ball covers, clubs, pucks, and a variety of other sporting apparatus and recreation equipment, footwear, protection equipment, medical devices, interior, exterior and under the hood auto parts, power tools, hosing, tubing, pipe, tape, valves, window, door and other construction articles, seals and gaskets, wire and cable jacketing, carpet underlay, business equipment, electronic equipment, connectors electrical parts, containers, appliance housings, toys etc., or parts contained by the preceding articles.

Specific embodiments of the invention provide:

A polyurethane prepolymer prepared by reacting
a) a polyol component comprising one or more polycarbonate diol comprising a repeating unit of formula I wherein x is C₂₋₁₂, one or more co-polycarbonate polyol comprising repeating units of formula A and B⁵ in a molar ratio of 9:1 to 1:9 or 4:1 to 1:4, or a mixture thereof, with
b) a 3:1 to 12:1, e.g., a 5:1 to 8:1, molar excess of one or more polyisocyanate monomer comprising paraphenylene diisocyanate, toluidine diisocyanate, isophorone diisocyanate, 2,4-methylene bis (phenylisocyanate), 4,4′-methylene bis(phenylisocyanate), toluene-2,4-diisocyanate, toluene-2,6-diisocyanate, diphenyl-4,4′-diisocyanate, dibenzyl-4,4′-diisocyanate, stilbene-4,4′-diisocyanate, 1,4-cyclohexyl diisocyanate, a geometric isomer of 1,1′-methylene-bis(4-isocyanatocyclohexane), and/or hexamethylene diisocyanate; e.g., paraphenylene diisocyanate, 4,4′-methylene bis (phenylisocyanate), hexamethylene diisocyanate, toluene-2,4-diisocyanate and/or toluene-2,6-diisocyanate;
   optionally in the presence of
c) an inert solvent having a boiling point of 120° C. or higher comprising an alkylated aromatic hydrocarbon, chlorinated benzene, glutarate, succinate, adipate, sebacate, phthalate, butyrolactone, ethylene carbonate, propylene carbonate and/or N-methylpyrollidone, e.g., an adipate or a phthalate;

and then subjecting the product mixture obtained to a distillation process, typically under reduced pressure, e.g., processing the product mixture a wiped film evaporator, to remove unreacted diisocyanate monomer and any optional inert solvent, to obtain a prepolymer comprising less than 0.5 wt %, typically 0.1 wt % or less, unreacted diisocyanate monomer and less than 0.5 wt %, typically 0.1 wt % or less, of any optional solvent.

A polyurethane curing composition comprising a selected ratio of a prepolymer from the specific embodiments above and a curing agent, prepared by adding to a liquid form of the prepolymer, heating may be required to place the prepolymer in a molten state or a solvent may be added, a curing agent comprising one or more polyol, polyamine, or polyamine derivative, e.g., one or more of:
ethylene glycol, 1,3-propanediol, 1,4-butanediol, 1,5-pentanediol, 1,6-hexanediol, neopentyl glycol, trimethylol propane, triethanolamine, 1,4-cyclohexane dimethanol, cyclohexane diol, hydroquinone-bis-hydroxyethyl ether, diethylene glycol dipropylene glycol, dibutylene glycol, triethylene glycol, polyether diol having a MW of 250 or higher, ethylene diamine, hexamethylene diamine, isophorone diamine, xylylene diamine, methylenedianiline, naphthalene-1,5-diamine, phenylene diamine, toluene-2,4-diamine, 4,4′-methylene-bis(3-chloroaniline), 4,4′-methylene-bis(3-chloro-2,6-diethylaniline), diethyl toluene diamine, tertiary butyl toluene diamine, dimethylthio-toluene diamine, trimethylene glycol di-p-amino-benzoate, 1,2-bis(2-aminophenylthio)ethane, and/or a methylenedianiline-sodium chloride complex.

In some specific embodiments the curing agent of the polyurethane curing composition comprises ethylene glycol, 1,3-propanediol, 1,4-butanediol, 1,6-hexanediol, trimethylol propane, 1,4-cyclohexane dimethanol, hydroquinone-bis-hydroxyethyl ether, diethylene glycol, polyether diol having a MW of 250 or higher, hexamethylene diamine, isophorone diamine, methylenedianiline, toluene-2,4-diamine, 4,4′-methylene-bis(3-chloroaniline), 4,4′-methylene-bis(3-chloro-2,6-diethylaniline), diethyl toluene diamine, tertiary butyl toluene diamine, dimethylthio-toluene diamine, trimethylene glycol di-p-amino-benzoate, 1,2-bis(2-aminophenylthio)ethane, and/or a methylenedianiline-sodium chloride complex.

For example, in some embodiments, the curative comprises a C₂₋₆ diol, cyclohexane dimethanol and/or hydroquinone-bis-hydroxyethyl ether, e.g., 1,4-butane diol and/or hydroquinone-bis-hydroxyethyl ether, or a methylenedianiline-sodium chloride complex.

The processing characteristics of the prepolymers and urethane polymers of the invention, and the performance characteristics of the urethane polymers, are well suited for a number of end uses, and other embodiments of the invention are to articles and methods for preparing articles, that are useful in paper making, drilling, and other industries. For example, polyurethanes of the invention can be used in the manufacture of presses, rolls, shoe press belts etc., found in the machinery used in paper, tissue, and cardboard manufacture. Prepolymers of the invention can be combined with selected curing and thixotropic agents and used in rotational casting methods for the preparation of high performance rolls and the like.

Polymers of the invention prepared from polycarbonate/polyether prepolymers are well suited for use in, e.g., flexible sleeves found in bend stiffeners, i.e., devices that provide localized stiffing to elongated and flexible devices such as rope, cable, electrical and fiber optic cables, tubing, pipe, and other conduits. For example, marine cabling and piping systems such as found in oil production where well treatment fluids often are delivered to the well, and production fluids are withdrawn from the well, through flexible conduits. As described in U.S. Pat. No. 9,339,948, the sleeve of a stiffener must flexible, exhibit the necessary combination of stiffness and flexibility over a range temperature, and resistant to fatigue. Hydrolytic stability is an important attribute, especially in marine applications. The combined properties of toughness, resilience, hydrolytic resistance and flexibility in polyurethanes prepared from polycarbonate/polyether prepolymers make them a good choice for the production of stiffener sleeves.

### EXAMPLES

In the following examples “parts” refers to parts by weight, “%” refers to % by weight.

### Example I

Prepolymer: To a batch reaction flask equipped with nitrogen sweep, an agitator, a thermometer, a heating mantle, and a vacuum source, was charged 800 parts p-phenylene diisocyanate (PPDI) in 3200 parts of dimethyl adipate (DMA) and then 1904 parts of polycarbonate polyol PC 2000 (MW 1904), creating a mixture with a molar ratio of PPDI to PC diol, (hence the equivalent ratio of NCO groups to OH groups) of 5:1. The mixture was heated for 6 hours at 80° C. with vacuum of 1-10 torr, the crude reaction mixture was then processed through a wiped film evaporator to remove unreacted PPDI and DMA to leave a stripped prepolymer having 3.6% available isocyanate groups and containing less than 0.1% free PPDI, and 0.1% max dimethyl adipate.

Elastomer: 90 g of the prepolymer was mixed with 7.6 g molten HQEE and the resulting mixture was poured into molds and cured/post cured at 125° C. for 16 hours. Molded articles with excellent toughness were obtained upon demolding after the curing/post curing cycle.

### Example II

Prepolymer: Following the prepolymer procedure of Example 1, a mixture of 800 parts p-phenylene diisocyanate (PPDI), 3200 parts of DMA, and 952 parts 1,5/1,6 pentane/hexane-Polycarbonate polyol CO—PC 1000 (MW 952) having a molar ratio of PPDI to PC diol, and equivalent ratio of NCO groups to OH groups, of 5:1, was mixed for 6 hours at 80° C. with vacuum of 1-10 torr to provide a crude reaction mixture, which was processed through a wiped film evaporator as above to leave a stripped prepolymer having 5.8% available isocyanate groups and containing less than 0.1% free PPDI, and 0.1% max DMA.

Elastomer: 90 g of the prepolymer was mixed with 12.4 g molten HQEE and the resulting mixture was poured into molds and cured/post cured at 125° C. for 16 hours. Molded articles with excellent toughness were obtained upon demolding after the curing/post curing cycle.

### Example III

Prepolymer: Following the prepolymer procedure of Example 1, a mixture of 800 parts hexamethylene diisocyanate (HDI) and 906 parts of polycarbonate polyol 2000 (MW 1904) having a molar ratio of HDI to PC diol, and equivalent ratio of NCO groups to OH groups, of 10:1, was mixed for 6 hours at 80° C. with vacuum of 1-10 torr to provide a crude reaction mixture, which was processed through a wiped film evaporator as above to leave a stripped prepolymer having 3.8% available isocyanate groups and containing less than 0.1% free HDI.

Elastomer: 90 g of the prepolymer was mixed with 14.6 g molten 4,4′-methylene-bis(3-chloro-2,6-diethylaniline) (MCDEA) and the resulting mixture was poured into molds and cured/post cured at 125° C. for 16 hours. Molded articles with excellent toughness were obtained upon demolding after the curing/post curing cycle.

### Example IV

Prepolymer: Following the prepolymer procedure of Example 1, a mixture of 800 parts hexamethylene diisocyanate (HDI) and a blend of 410 parts of polycarbonate polyol PC 1000 (1000 MW) and 125 parts PC 2000 (1904 MW) having a molar ratio of HDI to PC diol, and equivalent ratio of NCO groups to OH groups, of 10:1, was mixed for 6 hours at 80° C. with vacuum of 1-10 torr to provide a crude reaction mixture, which was processed through a wiped film evaporator as above to leave a stripped prepolymer having 5.6% available isocyanate groups and containing less than 0.1% free HDI.

Elastomer: 90 g of the prepolymer was mixed with 22.0 g molten 4,4′-methylene-bis(3-chloro-2,6-diethylaniline) (MCDEA) and the resulting mixture was poured into molds and cured/post cured at 125° C. for 16 hours. Molded articles with excellent toughness were obtained upon demolding after the curing/post curing cycle.

Table 1 shows physical properties of the elastomers made from the low free monomer polycarbonate prepolymers above.

TABLE 1
Properties of the elastomers made from low free monomer PC prepolymers

| Elastomer | Example I | Example II | Example III | Example IV |
|---|---|---|---|---|
| Hardness | 94A | 60D | 93A | 50D |
| Rebound, % | 51 | 35 | 44 | 48 |
| Tensile Strength, psi | 7200 | 7500 | 5130 | 4270 |
| Elongation, % | 550 | 500 | 350 | 180 |

Elastomers from Examples I and IV were aged at elevated temperatures for 3 weeks and tested for retention of hardness. The results listed in Table 3 illustrates the very small change in hardness under the conditions for the elastomers.

TABLE 3
Properties retention

| | Initial | After | After |
|---|---|---|---|
| | Hardness | 100° C./3 weeks | 150° C./3 weeks |
| Example I | 94A | 93A | 93A |
| Example IV | 50D | 53D | 45D |

### Comparative Example A

1904 parts polycarbonate polyol PC 2000 (1904 MW) was charged to a batch reaction flask equipped with nitrogen sweep, an agitator, a thermometer, a heating mantle, and a vacuum source, followed by 320 parts p-phenylene diisocyanate (PPDI). The mixture, having a molar ratio of PPDI to PC (and NCO:OH ratio) of 2:1, was heated for 6 hours at 80° C. with vacuum of 1-10 torr to provide a prepolymer having 3.7% available isocyanate groups and 2.1% free PPDI.

### Comparative Example B

952 parts Polycarbonate polyol PC 1000 (952 MW) was charged to a batch reaction flask equipped with nitrogen sweep, an agitator, a thermometer, a heating mantle, and a vacuum source, followed by 320 parts p-phenylene diisocyanate (PPDI). The mixture, having a molar ratio of PPDI to PC (and NCO:OH ratio) of 2:1, was heated for 6 hours at 80° C. with vacuum of 1-10 torr to provide a prepolymer having 6.5% available isocyanate groups and 3.5% free PPDI.

Table 3 compares important processing characteristics of the low free monomer prepolymers of Examples I and II to those of Comp Examples A and B. The lower viscosity and/or melting point of the Inventive Examples I and II illustrate processing advantages for the inventive prepolymers.

TABLE 3
Prepolymer processing characteristics

| | | | Comp | Comp |
|---|---|---|---|---|
| | Example I | Example II | Ex A | Ex B |
| % NCO | 3.6 | 5.8 | 3.7 | 6.5 |
| Melting point, ° C. | 75 | 60 | 80 | 105 |
| Viscosity at 100° C., | 30 | 20 | 60 | 30 |
| poise | | | | |

### Comparative Example C

13.5 g molten HQEE and 100 g of a conventional MDI/polyester prepolymer VIBRATHANE 8030 (5.8% available isocyanate groups) were mixed at 90° C., the resulting mixture was poured into molds and cured/post cured at 100° C. for 16 hours. Cured parts were obtained after demolding after curing cycle.

### Comparative Example D

12.6 g of MOCA and 100 g of a typical TDI/polyester prepolymer ADIPRENE LF1900A (4.2% available isocyanate groups) were mixed at 90° C., the resulting mixture was poured into molds and cured/post cured at 100° C. for 16 hours. Cured parts were obtained after demolding after curing cycle.

The elastomers obtained from Examples I and II and Comparative examples C and D were heat aged in IRM 903 oil at 150° C. for 3 weeks after which the physical properties of the elastomers were tested. The data in Table 4 illustrates the superiority and excellent retention of properties of the elastomers prepared from the low free monomer polycarbonate prepolymers of the invention.

TABLE 4
Elastomer properties after IRM 903 oil aging at 150° C. for three weeks

| | Example I | Example II | Comp Ex C | Comp Ex D |
|---|---|---|---|---|
| Prepolymer | LFPPDI/PC | LFPPDI/PC | MDI/Polyester | TDI/Polyester |
| % NCO | 3.6 | 5.8 | 5.8 | 4.2 |
| Curative | HQEE | HQEE | HQEE | MOCA |
| Tensile, psi | 1820 | 1010 | 460 | Destroyed |
| Elongation, | 590 | 33 | 9 | ″ |
| % | | | | |
| Split Tear, | 25 | 22 | No strength | ″ |
| pli | | | | |

What is claimed:

1. An isocyanate terminated, polycarbonate based polyurethane prepolymer, obtained by the reaction of one or more polyisocyanate monomer with a polyol component comprising one or more polyol, wherein at least one polyol is a polycarbonate polyol comprising a repeating unit of formula I or a co-polycarbonate polyol comprising more than one repeating unit of formula I 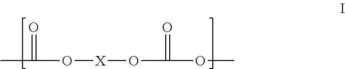
wherein X is selected from the group consisting of C₂₋₁₂ alkyl groups, wherein the prepolymer has a free poly isocyanate monomer content of less than 1 wt %, based on the weight of the prepolymer.

2. The prepolymer according to claim 1 having a free polyisocyanate monomer content of less than 0.1 wt %, based on the weight of the prepolymer.

3. The prepolymer according to claim 1, wherein the one or more polyols comprises one or more co-polycarbonate polyols comprising a repeating unit of formula A and one or more repeating units of formula B 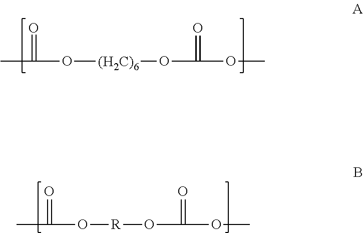
wherein R is C₂₋₁₂ alkyl other than straight chain C₆H₁₂, in a molar ratio of A to all repeating units of formula B of from 9:1 to 1:9.

4. The prepolymer according to claim 3 wherein at least 50% of the one or more repeating units of formula B in at least one of the one or more co-polycarbonate polyols is of formula B⁵

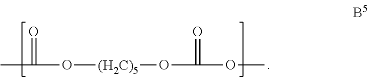

5. The prepolymer according to claim 4 wherein 60 to 100% of all repeating units in at least one of the one or more co-polycarbonate polyols are of formula A and B⁵.

6. The prepolymer according to claim 5 having a free polyisocyanate monomer content of less than 0.1 wt %, based on the weight of the prepolymer.

7. The prepolymer according to claim 1 wherein at least one polyol is a polycarbonate polyol comprising a repeating unit of formula I or a co-polycarbonate polyol comprising more than one repeating units of formula I 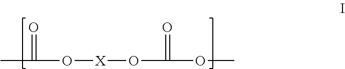
wherein X is selected from the group consisting of C₅₋₆ alkyl groups.

8. The prepolymer according to claim 7 having a free polyisocyanate monomer content of less than 0.1 wt %, based on the weight of the prepolymer.

9. The prepolymer according to claim 1 wherein the one or more polyisocyanate monomer comprises paraphenylene diisocyanate, toluidine diisocyanate, isophorone diisocyanate, 2,4- and/or 4,4′-methylene bis (phenylisocyanate), toluene-2,4-diisocyanate, toluene-2,6-diisocyanate, naphthalene-1,5-diisocyanate, diphenyl-4,4′-diisocyanate, dibenzyl-4,4′-diisocyanate, stilbene-4,4′-diisocyanate, benzophenone-4,4′diisocyanate, 1,3- and 1,4-xylene diisocyanates, 1,6-hexamethylene diisocyanate, 1,3-cyclohexyl diisocyanate, 1,4-cyclohexyl diisocyanate, and or geometric isomers of 1,1′-methylene-bis(4-isocyanatocyclohexane).

10. The prepolymer according to claim 8 wherein the one or more polyisocyanate monomer comprises paraphenylene diisocyanate, 4,4′-methylene bis (phenylisocyanate), toluene-2,4-diisocyanate, toluene-2,6-diisocyanate and/or 1,6-hexamethylene diisocyanate.

11. The prepolymer according to claim 2 wherein the one or more polyisocyanate monomer comprises paraphenylene diisocyanate, toluidine diisocyanate, isophorone diisocyanate, 2,4- and/or 4,4′-methylene bis (phenylisocyanate), toluene-2,4-diisocyanate, toluene-2,6-diisocyanate, naphthalene-1,5-diisocyanate, diphenyl-4,4′-diisocyanate, dibenzyl-4,4′-diisocyanate, stilbene-4,4′-diisocyanate, benzophenone-4,4′diisocyanate, 1,3- and 1,4-xylene diisocyanates, 1,6-hexamethylene diisocyanate, 1,3-cyclohexyl diisocyanate, 1,4-cyclohexyl diisocyanate, and or geometric isomers of 1,1′-methylene-bis(4-isocyanatocyclohexane).

12. The prepolymer according to claim 1 obtained by a process comprising reacting one or more polyisocyanate monomer with a polyol component comprising one or more polyols wherein at least one polyol is a polycarbonate polyol comprising a repeating unit of formula I or a co-polycarbonate polyol comprising more than one repeating units of formula I 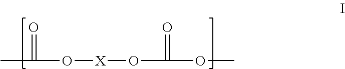
wherein X is selected from the group consisting of C₂₋₁₂ alkyl groups, followed by removing unreacted polyisocyanate monomer by distillation under reduced pressure optionally in the presence of one or more inert solvents having a boiling point of 120° C. or higher selected from hydrocarbons, esters, diesters, lactones carbonates and amides.

13. The prepolymer according to claim 2 obtained by a process comprising reacting one or more polyisocyanate monomer with a polyol component comprising one or more polyols wherein at least one polyol is a polycarbonate polyol comprising a repeating unit of formula I or a co-polycarbonate polyol comprising more than one repeating units of formula I 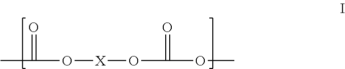
wherein X is selected from the group consisting of C₂₋₁₂ alkyl groups, followed by removing unreacted polyisocyanate monomer by distillation under reduced pressure optionally in the presence of one or more inert solvents having a boiling point of 120° C. or higher selected from hydrocarbons, esters, diesters, lactones carbonates and amides.

14. A process for preparing a prepolymer comprising reacting one or more polyisocyanate monomer with a polyol component comprising one or more polyols wherein at least one polyol is a polycarbonate polyol comprising a repeating unit of formula I or a co-polycarbonate polyol comprising more than one repeating units of formula I 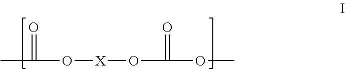
wherein X is selected from the group consisting of C₂₋₁₂ alkyl groups, followed by removing unreacted polyisocyanate monomer by distillation under reduced pressure to produce a prepolymer having a free polyisocyanate monomer content of less than 1 wt %, based on the weight of the prepolymer.

15. The process according to claim 14 wherein the prepolymer has a free polyisocyanate monomer content of less than 0.1 wt %, based on the weight of the prepolymer.

16. The process according to claim 14 wherein unreacted polyisocyanate monomer is removed by distillation under reduced pressure in the presence of one or more inert solvents having a boiling point of 120° C. or higher selected from hydrocarbons, esters, diesters, lactones carbonates and amides.

17. The process according to claim 15 wherein unreacted polyisocyanate monomer is removed by distillation under reduced pressure in the presence of one or more inert solvents having a boiling point of 120° C. or higher selected from hydrocarbons, esters, diesters, lactones carbonates and amides.

18. A polyurethane curing composition comprising a prepolymer according to claim 1 and a curing agent comprising one or more polyol, polyamine, polyamine derivative or a combination thereof.

19. A polyurethane elastomer prepared by curing the polyurethane curing composition according to claim 18.
